(19) United States
(12) Patent Application Publication
(10) Pub. No.: US 2018/0118521 A1
(43) Pub. Date: May 3, 2018

(54) ESCALATOR HAVING COMMON RETURN RAILS

(71) Applicant: INVENTIO AG, Hergiswil (CH)

(72) Inventors: Michael Matheisl, Vosendorf (AT); Thomas Novacek, Schwechat (AT); Georg Wagenleitner, Wien (AT)

(21) Appl. No.: 15/567,010

(22) PCT Filed: Apr. 1, 2016
(86) PCT No.: PCT/EP2016/057197

§ 371 Date: Oct. 16, 2017

(30) Foreign Application Priority Data
Apr. 16, 2015 (EP) 15163933.3

(51) Int. Cl. B66B 23/14

(52) U.S. Cl. CPC B66B 23/14

(57) ABSTRACT

An escalator comprises two deflection regions and a step belt arranged so as to circulate between the deflection regions. The step belt has pivotable steps, the pivoting motions of the which are defined during the circulation by the step rollers and idling rollers arranged on both sides of the steps and rolling on rails. Because of the circulating arrangement of the step belt, there is a forward run used to convey persons and goods and a return run used to return the steps. Instead of two separate return rails per step belt side, a common return rail is used for the idling rollers and the step rollers on each of the two sides of the step belt in the return run.

### TECHNICAL FIELD

The invention relates to an escalator comprising two deflection regions and a step belt arranged to circulate between the deflection regions. The step belt has pivotable steps, the pivoting motions of which during the circulation are defined by step rollers or chain rollers and idling rollers that are arranged on both sides of the steps and roll on rails. Because of the circulating arrangement, the step belt has a forward run used to convey persons and goods and a return run used to return the steps.

### DESCRIPTION OF RELATED ART

Escalators of the type cited are described in WO 2013/010838 A1, for example. In the forward run of the step belt the deflection regions are also access regions for the step belt. To make it as easy and safe as possible to enter and leave the step belt, in these access regions, the tread surfaces of at least three successive steps are held on the same horizontal plane before the tread surfaces of the individual steps are displaced vertically relative to one another, thus embodying a step, in the transition regions to the sloped or inclined segment of the escalator. The step rollers and idling rollers arranged on both sides of each step are arranged on different levels relative to the tread surface of the step. The arrangement on different levels has the advantage that only one forward rail on which both the step rollers and the idling rollers roll has to be arranged in the sloped segment of the forward run on both sides of the step belt.

Consequently, in order to hold the tread surfaces of successive steps on the same horizontal level in the access regions, for each step belt side a first guide rail for guiding the step rollers is necessary and a second guide rail for guiding the idling rollers is necessary. The first guide rails and the second guide rails extend between the two deflection regions across the entire return region of the step belt. This embodiment makes it possible to minimize the installation height of the deflection regions, since the steps disposed in the return run may be pivoted into the most advantageous position affecting the installation height.

Therefore four guide rails are installed in the return run during the assembly of the escalator disclosed in WO 2013/010838 A1. This leads, first of all, to longer assembly times for the escalator, and, secondly, to higher material costs for attaching material and creating the attachment locations on structural parts of the escalator, such as, for example, frames, mounting plates, and the supporting structure.

U.S. Pat. No. 764,906 A discloses an escalator that has a common return rail for idling rollers and step rollers. These are separated in the deflection region, by means of a switch comprising a pivotable switch tongue, onto a first guide rail and a second guide rail in order to form in the entry region a large, flat tread surface from the tread surfaces of a plurality of steps.

The switch has the drawback that its switch tongue can get stuck due to soiling and wear. This could endanger users and destroy parts of the escalator if the step rollers and idling rollers are no longer separated properly.

### SUMMARY

The object of the present invention is to create an operationally reliable escalator comprising a cost-effectively configured return run.

This object is attained using an escalator comprising two deflection regions and a step belt arranged so as to circulate between the deflection regions, which step belt has pivotable steps. Their pivoting motions during the circulation are defined by step rollers or chain rollers and traction rollers as well as idling rollers that are arranged on both sides of the steps and roll on rails, wherein, because of the circulating arrangement, the step belt has a forward run used to convey persons and goods and a return run used to return the steps. To minimize material and assembly time, and therefore to minimize costs, a common return rail for the idling rollers and the step rollers is provided on each of the two sides of the step belt in the return run.

The common return rails are arranged in an inclined segment of the return run and a transition region is present between each of the two deflection regions and common return rails. Arranged in each of these two transition regions is a rotating conveyor device, wherein in a first circulating direction of the step belt the rotating conveyor device conveys the step rollers from the common return rail to a first guide rail arranged in the deflection region and conveys the idling rollers from the common return rail to a second guide rail arranged in the deflection region. In a second circulating direction of the step belt, the idling rollers and the step rollers are consequently brought together on the common return rail.

The bringing together or separation of step rollers and idling rollers in the transition region has the advantage, in particular, that the deflection regions have an installation height that at least does not exceed the installation heights of existing escalators.

The step belt normally has two link chains that are connected to one another transverse to the circulating direction by means of step axes. For instance, the step rollers may be rotatably borne on these step axes and the steps may be pivotably arranged thereon. Due to this design, the two link chains are arranged on both sides of the step belt and the step axes cross the theoretical travel path of the idling rollers in the transition regions. The travel path is a theoretical travel path because in this region there must be an interruption or gap between the second guide rail and the return rail to permit the step axes to pass through. Naturally other traction means such as, for example, belts, toothed belts, steel cables, and the like may be used instead of the link chains.

However, for the idling rollers to be able to travel onto the second guide rail allocated to them, provided in the region of this interruption or gap is a rotating conveyor device that conveys an approaching idling roller onto the second guide rail. Further, the rotating conveyor device must be designed such that an approaching step axis and step roller can cross this region with no interference. “Rotating conveyor device” shall not necessarily be construed to mean that the entire conveyor device rotates. The entire conveyor device may be rotatable, but it is also possible for just parts of the conveyor device to be rotatable.

In a first embodiment, the rotating conveyor device of a transition region may preferably have two conveyor rotors. One of these conveyor rotors is rotatably arranged in each region of the interruption so that conveyor rotors are present on both sides of the step belt. It is also possible, however, for only one conveyor rotor to be provided, however this could load the step belt asymmetrically.

The step rollers and idling rollers cross these conveyor rotors in an alternating manner. Because of the design of the conveyor rotors, the step rollers and idling rollers cross them on different travel paths and are therefore separated onto the first guide rail or onto the second guide rail. To ensure disturbance-free functioning, the two conveyor rotors of one transition region are preferably mechanically linked to one another such that both have the same rotational speed and direction.

In a second embodiment, the rotating conveyor device may have at least one conveyor belt that is arranged revolving between two belt pulleys and that engages the step in the transition region. The belt pulleys are arranged such that in the transition region the step moves into position against a strand of the conveyor belt. The conveyor belt preferably acts directly on the step body of the step so that the latter is pivoted in the desired direction by the conveyor belt. Since the step body has a triangular cross-section along its width, its rear edge is preferably positioned against the conveyor belt such that the idling roller in the transition region is pressed against a guide surface that connects the second guide rail with the common return rail and is arranged above the travel paths of the idling roller and step roller. Because of this, the idling roller travels into the travel path of the second guide rail.

Since the conveyor belt is arranged only in the transition region, the step body loses contact with the conveyor belt as soon as the idling roller has attained a functionally secure position on the travel path of the second guide rail. The step forward edge arranged in the region of the step axis never moves so that it is positioned against the conveyor belt, so that, due to the tractive force of the link chain, the step roller is held on its travel path, which runs or is arranged between the common return rail and the first guide rail.

In a third embodiment, the rotating conveyor device may have at least one conveying wheel that engages the step in the transition region. The conveying wheel essentially acts on the step in the same manner as the conveyor belt described in the foregoing. As soon as a step rear edge that is to be moved towards the conveying wheel touches the conveying wheel, the step body of the step is pivoted so that the idling roller is directed along the guide surface into the second guide rail. The shape or curves of the guide surface is/are preferably matched to the position and diameter of the conveying wheel so that the steps, when traveling through the transition region, are subjected to the least possible mechanical loads caused by the rotating conveyor device.

All three embodiments described in the foregoing may be entirely passive rotating conveyor devices whose movable parts, such as conveyor rotors, conveyor belts, or conveying wheel, are driven solely by direct contact with parts of the step belt.

To further reduce mechanical loads caused by the rotating conveyor device, the rotating conveyor device or its conveyor rotors, conveyor belts, or conveying wheel may also be actively driven. For instance, the rotating conveyor device may be driven directly by the step belt. In this case, for instance, the movement of its traction means may be picked up mechanically and transmitted to the movable parts of the rotating conveyor device. A mechanical pick-up may be effected, for instance, by a chain wheel if the traction means is a link chain.

Naturally, the rotating conveyor device may also be driven by a conveyor drive that is independent of the step belt. Such a conveyor drive may be, for instance, an electric motor, a hydraulic motor, or the like.

For ensuring proper functioning, a monitoring device that has at least one sensor and/or switch and that monitors the correct separation of the step rollers and idling rollers in the transition region may be present in the escalator. For instance, if an idling roller is directed into the first guide rail instead of in the second roller, the monitoring device generates an error signal that is forwarded to a control device for the escalator. The control device for the escalator immediately brakes the step belt when there is an error signal.

The rotating conveyor device can also cause noises that could unsettle the users of the escalator. To eliminate or at least minimize these noises, a noise compensation device comprising at least one noise recording sensor and at least one speaker may be present in the escalator. The at least one noise recording sensor and the at least one speaker are preferably arranged in the region of the transition region and/or of the deflection region. Naturally, other operating noises from the escalator, such as for instance running noises for the step belt in the deflection regions or the noise of the drive motor, may also be compensated by the noise compensation device.

Since many escalators are used in department stores, the escalator should have as wide a step belt as possible and as narrow an installation width as possible so that the least possible amount of sales area is lost. The common return rail contributes significantly to a favorable installation width ratio, since the step rollers and the idling rollers roll onto closely adjacent, parallel travel paths on the associated common return rail. The distance between the travel paths is determine merely by the embodiment and arrangement of the traction means, since the idling roller must pivot past the traction means. If the traction means are attached to the outermost ends of the step axes on both sides of the step belt, the step rollers and idling rollers can also roll on the common return rails on overlapping travel paths. The two travel paths of the idling rollers and the step rollers are preferably arranged on the same level of the return rails.

Since, as described in the foregoing, the common return rail for step rollers and idling rollers permits an escalator that can be very narrow, this design may also be used for modernizing existing escalators. One possible method for modernizing an existing escalator has the steps that, first, all existing mechanical components are removed except for the support structure or frame of the existing escalator. Then the new mechanical components are installed, wherein the new mechanical components comprise a step belt arranged so as to circulate that has pivotable belts, the pivoting motions of which during the circulation are defined by step rollers and idling rollers that are arranged on both sides of the steps and roll on rails. Further, the mechanical components comprise a common return rail for the idling rollers and the step rollers of the step belt on each of the two sides of the step belt.

Accordingly, all other components described in the foregoing, such as the various embodiments of the rotating conveyor device, conveyor drives, noise compensation devices, and the like may also be installed in the escalator to be modernized.

### BRIEF DESCRIPTION OF THE DRAWINGS

Preferred exemplary embodiments of the invention are explained in more detail in the description below on the basis of the attached drawings, in which corresponding elements are denoted by the same reference numbers. Shown are:

FIG. 1: a schematic representation of an escalator comprising a support structure or truss and two deflection regions, wherein arranged in the support structure and in the return run is a circulating step belt, the step rollers and idling rollers of which roll on a common return rail.

FIG. 2: a section through the escalator along the line A-A of FIG. 1, with frames as carriers of the forward rails and of the common return rails;

FIGS. 3A-3D: depicted in four side views, the manner of functioning of a rotating conveyor device in a first embodiment with conveyor rotors for separating or bringing together step rollers and idling rollers of the step belt in the transition regions of the escalator from FIG. 1;

FIG. 4: in a three-dimensional elevation, a rotating conveyor device in a second embodiment for separating or bringing together step rollers and idling rollers of the step belt in the transition regions of the escalator from FIG. 1;

FIG. 5: in a three-dimensional elevation, a rotating conveyor device in a third embodiment for separating or bringing together step rollers and idling rollers of the step belt in the transition regions of the escalator from FIG. 1.

### DETAILED DESCRIPTION

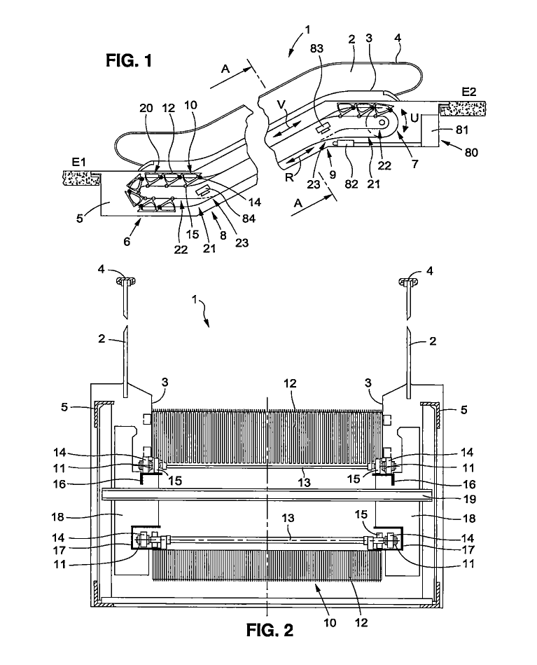

FIGS. 1 and 2 provide a schematic representation of an elevator 1 comprising a support structure 5 or truss 5 and two deflection regions 6, 7. The escalator 1 connects a first level E1 with a second level E2. A circulating step belt 10 is arranged in the support structure 5. The step belt 10 is bordered on the side by two balustrade bases 3 that extend in the longitudinal direction of the escalator 1 between the first level E1 and the second level E2. In addition, one circulating handrail 4 for each balustrade 2 is arranged on the balustrade base 3. The step belt 10 has at least one traction means 11 and a plurality of steps 12. Because of the circulating arrangement of the step belt 10, there is a forward run V used to convey persons and goods and a return run R used to return the steps 12.

The step belt 10 depicted in greater detail in FIG. 2 has one traction means 11, embodied as a link chain, on each side. Naturally, other traction means 11 such as, for example, belts, steel cables, and the like may be used instead of the link chains. The two link chains 11 are connected with one another transverse to the circulating direction U by means of step axes 13. Rotatably borne on these step axes 13 are step rollers 14 and the steps 12 are pivotably arranged thereon. The steps 12 also have idling rollers 15. The pivoting motions of the steps 12 are defined during the circulation U by the step rollers 14 and idling rollers 15 arranged on both sides of the steps 12 and rolling on rails 16, 17.

For the sake of better understanding, in FIG. 1 only the movement lines of the rotation axes for the step rollers 14 and idling rollers 15 are depicted, while FIG. 2 illustrates in detail the support structure 5, the frames 18 bearing the rails 16, 17, the transverse cross-ties 19 of the rails, and the traction means 11.

To minimize material and assembly time, a common return rail 17 for the idling rollers 15 and the step rollers 14 is provided on each of the two sides of the step belt 10 in the return run R. The common return rails 17 are arranged in an inclined segment of the return run R. A transition region 8, 9 is present between each of the two deflection regions 6, 7 and the common return rails 17.

As is depicted in FIG. 1, the deflection regions 6, 7 in the forward run V of the step belt 10 also act as access regions to the step belt 10. To make it as easy and safe as possible to enter and leave the step belt 10 in these access regions, the tread surfaces 20 of at least three successive steps 12 are held on the same horizontal plane before the tread surfaces 20 of the individual steps 12 are displaced vertically relative to one another, thus embodying a step, in the transition regions 8, 9 to the sloped or inclined segment of the escalator 1. The step rollers 14 and idling rollers 15 arranged on both sides of each step 12 are arranged on different planes from the tread surface 20 of the step 12. The arrangement on different planes has the advantage that only one forward rail 16 on which both the step rollers 14 and the idling rollers 15 roll has to be arranged in the inclined segment of the forward run V on both sides of the step belt 10.

Consequently, in order to hold the successive steps 12 on the same horizontal plane in the access regions for the deflection regions 6, 7, for each step belt side a first guide rail 21 for guiding the step rollers 14 and a second guide rail 22 for guiding the idling rollers 15 are necessary. The first guide rails 21 and the second guide rails 22 extend between the forward rails 16 and the return rails 17 in the two deflection regions 6, 7.

Since the two link chains 11 are arranged on both sides of the step belt 10 and are transversely connected by means of the step axes 13, the step axes 13 cross the theoretical travel path of the idling rollers 15 in the transition regions 8, 9. This travel path (depicted with the broken line) is theoretical because in this region there must be an interruption 23 or gap 23 between the second guide rail 22 and the return rail 17 to permit the step axes 13 to pass through.

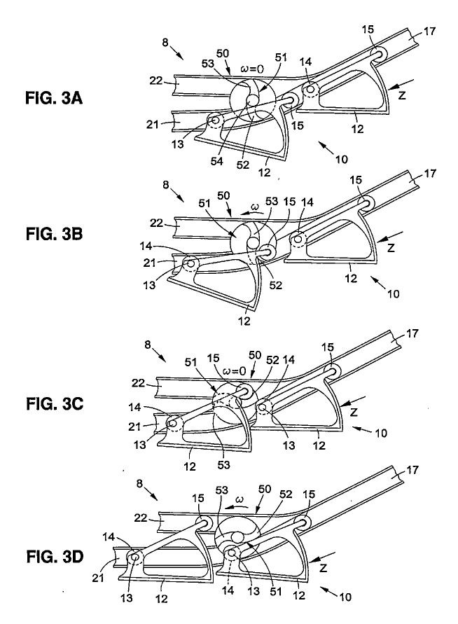

But in order for the idling rollers 15 to be led onto the second guide rail 22 allocated to them, the idling rollers 15 must be conveyed to the second guide rail in a suitable manner in this interruption 23 or gap 23. To this end, a rotating conveyor device 50, 60, 70 (see FIGS. 3A through 5) is arranged in the transition regions 8, 9, for each step belt side and each rotating conveyor device in a first circulating direction U of the step belt 10 conveys the step rollers 14 from the common return rails 17 to the first guide rail 21 and conveys the idling rollers 15 from the common return rail 17 to the second guide rail 22. In a second circulating direction U of the step belt 10, the idling rollers 15 and the step rollers 14 are consequently brought together onto the common return rail 17 by the rotating conveyor device 50, 60, 70.

The bringing together or separation of step rollers 14 and idling rollers 15 in the transition region 6, 7 has the advantage, in particular, that the deflection regions 6, 7 have an installation height that does not exceed the installation heights of existing escalators 1.

FIGS. 3A through 3D provide sectional side-view schematic representations of a first embodiment of a rotating conveyor device 50. The rotating conveyor device 50 depicted is arranged in the transition region 8 of the first level E1 (see FIG. 1) and has two conveyor rotors 51. The two conveyor rotors 51 are arranged on both sides of the step belt 10 so that, due to the sectional side views in FIGS. 3A through 3D, only one conveyor rotor 51 is shown. The conveyor rotor 51 has two conveyor wings 52, 53. Due to the rotation of the conveyor rotor 51 about a rotational axis 54, the conveyor wings 52, 53 engage in the theoretical travel path of the idling rollers 15.

The sequence of movements of the step rollers 14 and idling rollers 15 when passing the conveyor rotor 51 is described in the following, proceeding from FIG. 3A and going through FIG. 3D. For the sake of better understanding, only two steps 12 are shown; they cover the rotating conveyor device 50 in the direction of movement Z starting from the return rail 17.

In FIG. 3A the steps 12 move toward the conveyor rotor 51 in the direction of movement Z. Since conveyor wings 52, 53 are embodied on the conveyor rotor 51 and by rotating can project into the travel path of the idling roller 15, the idling roller 15 can be captured with the conveyor wings 52, 53 and conveyed onto the second guide track 22. In the exemplary embodiment depicted, the conveyor wing 52 is already in an ideal position for the sequence for capturing the approaching idling roller 15. The angular velocity o of the conveyor rotor is therefore indicated as ω=0.

Naturally the conveyor rotor 51 may also have an angular velocity to matched to the circulation speed of the step belt 10 so that the conveyor wings 52, 53 are not in the ideal position for the sequence until the idling roller 15 has reached the corresponding conveyor wing 52, 53, as depicted in FIG. 3B. As soon as the idling roller 15 has reached the corresponding conveyor wing 52, 53, the conveyor rotor 51 rotates at a prespecified angular velocity ω. This lifts the idling roller 15 and conveys it towards the second guide rail 22.

The angular velocity to of the conveyor rotors 51 must be ω=0 no later than when the conveyor wings 52, 53 have reached the position illustrated in FIG. 3C, because otherwise the conveyor wing 53 could project into the theoretical travel path of the step axis 13 of the trailing step 12 and would prevent it from passing through. In addition, the back of the conveyor wing 53 for the idling roller 15 forms a step-free transition between the conveyor rotor 51 and the second guide rail 22.

As soon as the idling roller 15 has left the conveyor wing 53, the conveyor rotor 51 can continue to rotate, as is illustrated in FIG. 3D. However, the angular velocity ω of the conveyor rotor 51 must be adjusted such that the conveyor wing 51 does not capture the step roller 14 or the step axis 13. If the step roller 14 has reached the first guide rail 21, the step axis 13 and the step roller 14 are outside the range of the conveyor wing 53 and the conveyor rotor 51 can continue to rotate until the initial situation depicted in FIG. 3A is attained again. The only difference from FIG. 3A is that, instead of the conveyor wing 52, the conveyor wing 53 is now ready to convey the next idling roller 15 to the second guide rail 22.

If the step belt 10 or its step rollers 14 and idling rollers 15 pass through the rotating conveyor device 50 in the opposing direction, step rollers 14 and idling rollers 15 are brought together on the common return rail 17, as this is depicted starting from FIG. 3D, proceeding through FIGS. 3C and 3B to FIG. 3A. The conveyor rotors 51 are preferably actively driven by means of a conveyor drive (not shown).

The preceding described conveying occurs with each idling roller 15 traversing the rotating conveyor device 50. Noises may occur when the step belt 10 is circulating. These noises may be eliminated, or at least reduced, using a noise compensation device 80, illustrated in FIG. 1, so that the users of the escalator 1 are not unsettled by them. The noise compensation device 80 eliminates the noises of the rotating conveyor device in that it generates complementary acoustic waves. Essential components of the noise compensation device 80 are at least one noise recording sensor 82 or microphone 82 that is arranged in the region of noises to be eliminated, one signal processing unit 81 for processing signals recorded by the noise recording sensor 82 and for generating complementary signals or overlay signals, and at least one speaker 83, 84 that is also arranged in the region of the noises to be eliminated and receives the complementary signals from the signal processing unit 81. Naturally, other operating noises for the escalator 1, such as for instance the running noises of the link chains 11 in the region of the deflection regions 6, 7 and/or the noise from the drive unit (not shown, includes drive motor and gearing) of the escalator 1 may also be eliminated, or at least minimized, by means of the noise compensation device 80.

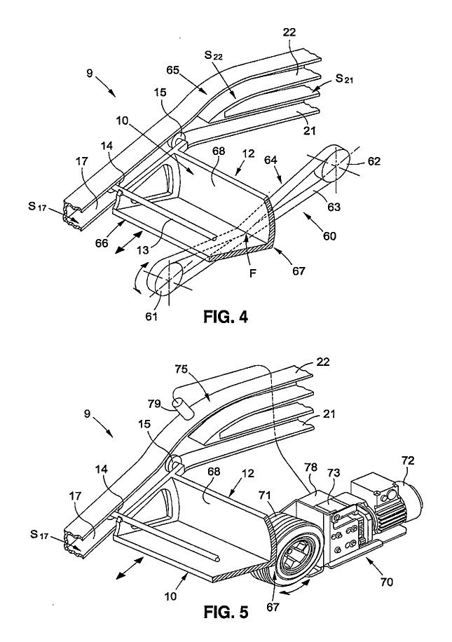

FIG. 4 provides a three-dimensional elevation of another embodiment of a rotating conveyor device 60 that is arranged, as an example, in the transition region 9 (see FIG. 1). For the sake of better understanding, only one step 12 of the step chain 10 is depicted, and only half of the rails 17, 21, 22 of the transition region 9 are depicted. This rotating conveyor device 60 has a conveyor belt 63 that is arranged circulating between two belt pulleys 61, 62 and that engages the step 12 in the transition region 9. Naturally the rotating conveyor device 60 may also have a plurality of conveyor belts 63 and belt pulleys 61, 62 arranged in parallel to one another.

The belt pulleys 61, 62 are arranged such that in the transition region 9 the step 12 moves into position against a strand 64 of the conveyor belt 63. The conveyor belt 63, because it is stretched between the two belt pulleys 61, 62 by means of a tensioning device (not shown), exerts a force F on the step 12. The conveyor belt 63 preferably acts directly on the step body 68 of the step 12 so that the latter is pivoted in the desired direction by the force F of the conveyor belt 63. Since the step body 68 has a triangular cross-section along its width, its rear edge 67 is preferably positioned against the conveyor belt 63 such that the idling roller 15 in the transition region 9 is pressed against a guide surface 65 that connects the two guide rails 22 with the common return rail 17 and is arranged above the guide tracks S₁₇ of the idling roller 15 and the step roller 14. Because of this, the idling roller 15 reliably travels into the travel path S₂₂ of the second guide rail 22. Since the conveyor belt 63 is arranged only in the transition region 9, the step body 68 loses contact with the conveyor belt 63 as soon as the idling roller 15 has attained a functionally secure position on the travel path S₂₂ of the second guide rail 22. The step forward edge 66 arranged in the region of the step axis 13 never moves so that it is positioned against the conveyor belt 63, so that, due to the tractive force of the link chain (which is not shown for the sake of better understanding), the step roller 14 is held on its travel path S₁₇, S₂₁, which runs or is arranged between the common return rail 17 and the first guide rail 21.

The rotating conveyor device 60 depicted in FIG. 4 may be driven passively. This means that its conveyor belts 63 may be driven solely using contact with the step body 68. In this case, the two belt pulleys 61, 62 must be borne rotatable with particularly low friction. To minimize the wear on the conveyor belt 63, the latter may be a toothed belt, the teeth of which are oriented towards the step rear edge 67. Naturally, however, the conveyor belt 63 may also be driven actively by means of a discrete conveyor drive (not shown in FIG. 4), wherein the rotational speed of the conveyor belt 63 is preferably adjusted to the speed of the step rear edge 67.

FIG. 5 provides a three-dimensional elevation view of another embodiment of a rotating conveyor device 70 that is arranged, as an example, in the transition region 9 (see FIG. 1). For the sake of better understanding, only one step 12 of the step chain 10 is depicted, and only half of the rails 17, 21, 22 of the transition region 9 are depicted. This rotating conveyor device 70 has a conveying wheel 71 that engages the step 12 in the transition region 9. The conveying wheel 71 functions in essentially the same manner as the conveyor belt 63 described in the foregoing.

As soon as a step rear edge 67 that is to be moved towards the conveyor wheel 71 touches the conveyor wheel 71, the step body 68 of the step 12 is pivoted so that the idling roller 15 is directed along a guide surface 75, for instance of the common return rail 17, into the second guide rail 22. This guide surface 75 connects the second guide rail 22 with the common return rail 17 and is arranged above the travel path S₁₇ of the idling roller 15 and the step roller 14. The shape or curve of the guide surface 75 is preferably matched to the position and diameter of the conveying wheel 71 so that the steps 12, when traveling through the transition region 9, are subjected to the least possible mechanical loads caused by the rotating conveyor device 70.

The conveying wheel 71 is actively driven by a conveyor drive 72, such as for instance the depicted electric motor 72 with attached gearing 73. Naturally, the conveying wheel 71 may also be driven by means of a hydraulic or pneumatic conveyor drive 72 or the like. It is also possible for the conveying wheel 71 to be driven entirely passively using contact with the step rear edge 67.

The conveying wheel 71 depicted in this exemplary embodiment in FIG. 5 is for instance a pneumatic tire with rim. If the pneumatic tire has too little internal pressure, or even no internal pressure, this can jeopardize the reliable conveyance of the idling rollers 15 from the common return rail 17 to the second guide rail 22. To prevent major damage, the rotating conveyor device 70 may be monitored by a monitoring device 78 comprising at least one sensor 79 and/or switch, so that the step belt 10 is stopped immediately if the conveying wheel 71 fails.

Although the invention has been described by showing specific exemplary embodiments, it is obvious that numerous other embodiment variants can be created with the knowledge of the present invention, for example, by combining the features of the individual embodiments with one another and/or exchanging individual functional units of the embodiments. One possible combination of the exemplary embodiments depicted in FIGS. 4 and 5 would result, for instance, if, instead of one conveyor belt, a plurality of conveying wheels comprising a small diameter were arranged behind one another. In addition, it is possible to employ a monitoring device in all of the exemplary embodiments. For the sake of better understanding, a depiction of drive units, signal transmitting means, power supply lines, and the like was largely forgone in FIGS. 1 through 5. These would, however, necessarily need to be provided so that the escalator can be used properly. Consequently, correspondingly configured escalators are covered by the scope of protection of the present claims.

1. An escalator comprising: two deflection regions; and a step belt arranged so as to circulate between the deflection regions, which step belt comprises pivotable steps, pivoting motions of which during the circulation are defined by step rollers and idling rollers that are arranged on both sides of the steps and roll on rails, wherein the step belt has two sides, a forward run used to convey persons and goods, and a return run used to return the steps, and a common return rail for the idling rollers and the step rollers is provided on each of the two sides of the step belt in the return run, wherein the common return rails are arranged in an inclined segment of the return run, and a transition region is present between each of the two deflection regions and common return rails, wherein arranged in each of these two transition regions is a rotating conveyor device, which rotating conveyor device, in a first circulating direction of the step belt, conveys the step rollers from the common return rail to a first guide rail arranged in the deflection region and conveys the idling rollers from the common return rail to a second guide rail arranged in the deflection region, and in a second circulating direction of the step belt, the rotating conveyor device brings together the idling rollers and the step rollers on the common return rail.

2. The escalator according to claim 1, wherein the rotating conveyor device has two conveyor rotors that are arranged on both sides of the step belt and the step rollers and idling rollers cross these conveyor rotors alternately.

3. The escalator according to claim 1, wherein the rotating conveyor device has at least one conveyor belt that is arranged circulating between at least two belt pulleys and that conveyor belt engages the step in the transition region.

4. The escalator according to claim 1, wherein the rotating conveyor device has at least one conveying wheel that engages the step in the transition region.

5. The escalator according to claim 1, wherein the rotating conveyor device is driven passively using direct contact with the step belt.

6. The escalator according to claim 1, wherein the rotating conveyor device is driven actively using a conveyor drive independent of the step belt or using the step belt.

7. The escalator according to claim 1, wherein a monitoring device comprising a sensor and/or switch is present for monitoring the step rollers and/or idling rollers.

8. The escalator according to claim 1, wherein a noise compensation device, comprising at least one noise recording sensor and at least one speaker, is present, which at least one noise recording sensor and which at least one speaker are arranged in of the transition region and/or deflection region.

9. A method for modernizing an existing escalator, the method comprising: removing all existing mechanical components except a support structure of the existing escalator; and installing new mechanical components, wherein: the new mechanical components comprise a circulating arranged step belt which comprises two sides and pivotable steps, the pivoting motions of which during the circulation are defined by step rollers and idling rollers that are arranged on both sides of the steps and roll on rails, the mechanical components furthermore comprises a common return rail for the idling rollers and the step rollers of the step belt on each of the two sides of the step belt, wherein the common return rails are arranged in an inclined segment of the return run, a transition region is present between each of the two deflection regions and common return rails, arranged in each of these two transition regions a rotating conveyor device, which rotating conveying device, in a first circulating direction of the step belt, conveys the step rollers from the common return rail to a first guide rail arranged in the deflection region and conveys the idling rollers from the common return rail to a second guide rail arranged the deflection region, and in a second circulating direction of the step belt, the rotating conveyor device brings together the idling rollers and the step rollers on the common return rail.

10. The escalator according to claim 3, wherein the rotating conveyor device is driven passively using direct contact with the step belt.

11. The escalator according to claim 4, wherein the rotating conveyor device is driven actively using a conveyor drive independent of the step belt or using the step belt.

12. The escalator according to claim 4, wherein a monitoring device comprising a sensor and/or switch is present for monitoring the step rollers and/or idling rollers.

13. The escalator according to claim 2, wherein a noise compensation device, comprising at least one noise recording sensor and at least one speaker, is present, which at least one noise recording sensor and which at least one speaker is arranged in the transition region and/or deflection region.

14. The escalator according to claim 3, wherein a noise compensation device, comprising at least one noise recording sensor and at least one speaker, is present, which at least one noise recording sensor and which at least one speaker is arranged in the transition region and/or deflection region.

15. The escalator according to claim 4, wherein a noise compensation device, comprising at least one noise recording sensor and at least one speaker, is present, which at least one noise recording sensor and which at least one speaker is arranged in the transition region and/or deflection region.

16. The escalator according to claim 5, wherein a noise compensation device, comprising at least one noise recording sensor and at least one speaker, is present, which at least one noise recording sensor and which at least one speaker is arranged in the transition region and/or deflection region.

17. The escalator according to claim 6, wherein a noise compensation device, comprising at least one noise recording sensor and at least one speaker, is present, which at least one noise recording sensor and which at least one speaker is arranged in the transition region and/or deflection region.

18. The escalator according to claim 7, wherein a noise compensation device, comprising at least one noise recording sensor and at least one speaker, is present, which at least one noise recording sensor and which at least one speaker is arranged in the transition region and/or deflection region.
